(19) United States
(12) Patent Application Publication
(10) Pub. No.: US 2018/0011413 A1
(43) Pub. Date: Jan. 11, 2018

(54) ELECTROSTATIC CHARGE IMAGE DEVELOPING TONER, DEVELOPER, AND IMAGE FORMING METHOD

(71) Applicant: Mitsubishi Chemical Corporation, Chiyoda-ku (JP)

(72) Inventor: Takatsugu TAKEHARA, Niigata (JP)

(73) Assignee: Mitsubishi Chemical Corporation, Chiyoda-ku (JP)

(21) Appl. No.: 15/714,404

(22) Filed: Sep. 25, 2017

Related U.S. Application Data
(63) Continuation of application No. PCT/JP2016/059756, filed on Mar. 25, 2016.

(30) Foreign Application Priority Data
Mar. 27, 2015 (JP) 2015-067190

(51) Int. Cl. G03G 9/097; G03G 9/087; G03G 9/10; G03G 9/113

(52) U.S. Cl. CPC G03G 9/09758; G03G 9/1138; G03G 9/1134; G03G 9/08711; G03G 9/10; G03G 9/1131

(57) ABSTRACT

An object of the present invention is to provide an electrostatic charge image developing toner, a two-component developer, and an image forming method, each capable of employing a two-component trickle touchdown developing system which ensures excellent image density stability and no occurrence of ghost and is used in an electrophotographic copier or an electrostatic recording device. The present invention provides an electrostatic charge image developing toner having positive chargeability; containing a styrene acrylic resin as the binding resin; and containing a nigrosine-containing positive charge control agent and a negative charge control agent as the charge control agent, in which the percentage content of the percentage content of the negative charge control agent in all charge control agents is not less than the percentage content of the positive charge control agent.

### TECHNICAL FIELD

The present invention relates to an electrostatic charge image developing toner, a two-component developer, and an image forming method using the same. More specifically, the present invention relates to an electrostatic charge image developing toner used for a two-component trickle touchdown developing system of charging a non-magnetic toner by use of a magnetic carrier; holding only a charged toner on a developing roll; and attaching a toner to develop an electrostatic latent image, a two-component developer, and an image forming method using the same.

### BACKGROUND ART

The dry developing system used for xerography generally includes a two-component developing system using a mixture of a carrier, such as iron powder and ferrite powder, and a toner, and a one-component developing system using no carrier.

Of these, in the two-component developing system, a toner is supplied to a developer composed of a carrier particle and a toner particle and filled into a developer tank. The supplied toner and the developer are stirred, and the supplied toner is thereby electrically charged to have a proper electrostatic charge and form a toner image on a photoreceptor. The toner image formed on a photoreceptor is transferred onto paper and fixed as an image.

In the two-component developing system, an electric charge of a toner which is necessary for development is imparted by a carrier particle. In comparison with a one-component developing system of imparting an electric charge to the toner by the contact with a member, a carrier particle is superior in terms of durability of the member, and an electric charge can thereby be more stably imparted over a long period of time than in the one-component developing system, as a result, the image quality is also stabilized.

However, in the two-component developing system, a two-component developer holding member carrying a two-component developer and an image holding member (photoreceptor) are facing each other, and this poses a problem that a carrier in the two-component developer comes into contact with and attaches to the image holding member to damage the surface of the image holding member, resulting in a short life of the image holding member.

The developing method for overcoming this problem includes a touchdown developing system. In the touchdown developing system, a toner holding member such as developing roller is disposed between an image holding member and a two-component developer holding member such as magnetic roller, and a toner in the two-component developer, to which an electric charge is imparted by a carrier held on the two-component developer holding member, is supplied to the toner holding member and forms a toner thin layer on the toner holding member.

The electrically charged toner in the thin layer flies in a space above the toner holding member and the image holding member, and an electrostatic latent image on the image holding member is thereby developed (touchdown development) and visualized as a toner image.

Unlike a two-component developing system, a toner holding member is present between a two-component developer holding member and an image holding member, and the image holding member is thereby prevented from generation of damage caused by contact or attachment of a carrier in the two-component developer to the photoreceptor of the image holding member. Accordingly, it has been reported that this system is suitable for extension of the life of the image holding member (Patent Document 1).

On the other hand, in the trickle developing system, a carrier is incorporated into a replenishment toner, and a carrier in which the electric charge imparting ability is reduced, for example, by separation of a coat agent on the carrier surface owing to stress produced from contact, etc. of carriers with each other or by spent of toner adhering to the carrier surface, is therefore replaced with a stress-free new carrier in the two-component developer.

It has been reported that this replacement of the carrier enables the carrier to efficiently and stably impart an electric charge to the toner and in turn, a homogeneous image is obtained over a long period of time (Patent Document 2).

Furthermore, in recent years, it has been reported that when the trickle developing system and a touchdown developing system are combined, i.e., the advantage of the trickle developing system enabling an electric charge to be stably imparted to the toner and the advantage of the touchdown developing system ensuring life extension by reducing damage of the image holding member (photoreceptor) are combined, a stable, high-quality image is obtained over a long period of time (Patent Document 3).

In addition, a long life is required of a copying machine, a multifunction printer, etc., and the developing system employed is shifting from the two-component developing system to, e.g., the trickle developing system more suitable for life extension, which yields a requirement that a carrier or a toner must also be designed to extend the life according to the developing system. For example, as to the carrier, a composition insusceptible to separation of the coating agent on the core material surface or contamination with, e.g., a toner composition or an external additive, and the shape, etc. of a carrier particle have been disclosed, and as to the toner, a composition, etc. of a binder resin has been reported (see, Patent Documents 4 to 6).

According to the reports of Patent Documents 2 to 4, as to the carrier, a carrier particle having on a core material surface a coating agent containing a fluororesin or a fluoroorganic compound is suitable in view of long life, since the carrier is insusceptible to contamination with a toner composition, an external gent, etc. and the coating agent is less likely to be separated from the carrier particle surface.

On the other hand, as to the charge control agent, it has been reported to use, as the toner for two-component developer, a toner containing a charge control agent differing in the polarity (Patent Document 7).

### BACKGROUND ART LITERATURE

### Patent Document

Patent Document 1: JP-A-2010-2891

Patent Document 2: JP-A-2007-199178

Patent Document 3: JP-A-2015-1605

Patent Document 4: JP-A-2004-177496

Patent Document 5: JP-A-2001-066826

Patent Document 6: JP-A-02-217869

Patent Document 7: JP-A-08-6296

### SUMMARY OF THE INVENTION

### Problems that the Invention is to Solve

According to studies by the present inventors, in a two-component trickle touchdown developing system reported in Patent Document 3, which is a combination of a trickle developing system and a touchdown developing system, a carrier particle coated with a fluororesin or a fluoroorganic compound has been expected to have a high ability of imparting an electric charge to the negatively charged side.

The present inventors have therefore thought that as a binder resin of toner used at the time of producing a two-component developer, a polyester resin having negative chargeability may be suitable as a negatively chargeable toner to obtain a sufficiently high image quality but is improper as a positively chargeable toner to obtain a sufficient image quality, because of too low chargeability.

On the other hand, in the case where the binder resin of toner is a styrene acrylic resin, as a positively chargeable toner, even when any positive charge control agent is used or the addition amount is adjusted, the positive chargeability of the toner is too high, and the toner attaches to the carrier surface by an electrostatic force.

As a result, the carrier surface is covered with the toner, drastically reducing the opportunity for the coating agent and the toner to come into direct contact, and the ability of the carrier of imparting an electric charge to the toner is impaired. Accordingly, it has been known that the toner cannot obtain a sufficient charge amount and is lowly charged to cause sheet surface contamination, etc., failing in obtaining a sufficient image quality.

In addition, even when a charge control agent having a different polarity is added as in Patent Document 7, unless the charge control agent combined and the coating agent of the carrier particle are selected, a highly charged toner is formed, or the charge amount distribution becomes broad, causing an image failure of ghost, and it has been known that the toner is improper for an image forming method employing a two-component trickle touchdown developing toner.

The present invention has been made in consideration of these circumstances, and an object of the present invention is to provide an electrostatic charge image developing toner, a two-component developer, each ensuring that the image density stability is excellent and an image failure of ghost does not occur, and an image forming method employing a two-component trickle touchdown developing system using the same.

### Means for Solving the Problems

As a result of many intensive studies to solve the problems above, the present inventors have found that when a toner containing a styrene acrylic resin as a binder resin and containing a nigrosine-containing positive charge control agent and a negative charge control agent as charge control agents, with the percentage content of the negative charge control agent in all charge control agents being not less than the percentage content of the positive charge control agent, is used, in an image forming method employing a two-component trickle touchdown developing system, a proper toner charge amount is obtained, and toner attachment to the carrier particle surface is suppressed.

In particular, it has been found that use of a two-component developer containing the toner above and a carrier having a fluororesin or a fluoroorganic compound on the core material surface makes it possible to obtain an image forming method in which an electric charge is supplied to the toner without impairing the electric charge imparting ability of the carrier particle; no image failure of ghost occurs; and the image density stability is excellent.

Namely, the present invention relates to the followings.
[1] An electrostatic charge image developing toner containing a binder resin and a charge control agent, wherein:

the binder resin is a styrene acrylic resin,

the charge control agent contains a positive charge control agent and a negative charge control agent,

the positive charge control agent contains nigrosine,

the percentage content of the negative charge control agent in all charge control agents is not less than the percentage content of the positive charge control agent, and

the toner has positive chargeability.
[2] A two-component developer containing the electrostatic charge image developing toner according to the above [1] and a carrier, wherein the carrier has a fluororesin or a fluoroorganic compound on the core material surface.
[3] An image forming method containing:

continuously replenishing a developer containing a toner and a carrier with discharging an excessive developer,

generating a magnetic brush of the carrier by means of a magnetic roller,

supplying a toner to the developing roller surface from the magnetic brush to form a toner thin layer, and

selectively attaching the toner on the developing roller surface to an electrostatic latent image holding member according to an electrostatic latent image, wherein:

the carrier has a fluororesin or a fluoroorganic compound on the core material surface,

the toner contains a charge control agent and a binder resin composed of a styrene acrylic resin and has positive chargeability,

the charge control agent contains a positive charge control agent and a negative charge control agent, and

the positive charge control agent is nigrosine.
[4] The image forming method according to the above [3], wherein the toner on the developing roller surface is caused to selectively fly to an electrostatic latent image holding member in accordance with an electrostatic image.
[5] The image forming method according to the above [3] or [4], wherein the negative charge control agent is a charge control resin.
[6] An electrostatic charge image developing toner containing a binder resin and a charge control agent, wherein

the binder resin is a styrene acrylic resin,

the charge control agent contains a positive charge control agent and a negative charge control agent,

the positive charge control agent contains nigrosine, and

when a carrier particle having a fluororesin or a fluoroorganic compound is mixed with the toner to give a toner concentration of 8%, the toner charge amount Qa is from 15 to 30 [μC/g].

### Effect of the Invention

According to the present invention, the toner charge amount is proper, and attachment of the toner to the carrier particle surface is thereby suppressed. In turn, an electric charge can be supplied to the toner without impairing the charge imparting ability of the carrier particle. As a result, an electrostatic charge image developing toner, a two-component developer, and an image forming method using the same, each ensuring no occurrence of an image failure of ghost and excellent image density stability, can be provided.

### BRIEF DESCRIPTION OF THE DRAWINGS

FIG. 1 is a diagram illustrating one configuration example of the development section of an electrophotographic apparatus where the image forming method of the present invention is used.

### MODE FOR CARRYING OUT THE INVENTION

Although the present invention is described in detail below, the present invention is not limited to the following embodiments and can be implemented by making arbitrary modifications without departing from the gist of the present invention. In the following, the “electrostatic charge image developing toner” is sometimes simply referred to as “toner”.

The toner of the present invention is a toner used for a two-component trickle touchdown developer in combination with a carrier particle (hereinafter, sometimes simply referred to as a carrier) having, on the core material surface, a coating agent containing a fluororesin or a fluoroorganic compound. The toner of the present invention is characterized by having positive chargeability, containing a styrene acrylic resin as the binding resin, and containing a nigrosine-containing positive charge control agent and a negative charge control agent as the charge control agent, in which the percentage content of the negative charge control agent in all charge control agents is not less than the percentage content of the positive charge control agent.

### <1. Electrostatic Charge Image Developing Toner>

The electrostatic charge image developing toner of the present invention contains, as a toner mother particle, a binder resin and a charge control agent. The toner mother particle may additionally contain a coloring agent and a wax.

The toner of the present invention may have an external additive that is fixed or attached onto the surface of the toner mother particle.

Although the production method of the toner mother particle is not particularly limited as long as the effects of the present invention are not significantly impaired, either a melt-kneading pulverization method or a wet polymerization method such as emulsion polymerization method, suspension polymerization method or dissolution suspension method, may be used.

In the following, although the present invention is described by specifically referring to a melt-kneading pulverization method, the present invention is not limited only to a toner produced by a melt-kneading pulverization method.

In the present invention, the melt-kneading pulverization method is a method of dry-mixing a binder resin, a charge control agent, a coloring agent, a wax and, if desired, a magnetic material, etc.; melt-kneading the mixture in an extruder, etc.; and subjecting the kneaded material to pulverization and classification to obtain a toner mother particle. Thereafter, an external additive is attached or fixed to the toner mother particle surface, and a toner can thereby be obtained.

### (1-1. Binder Resin)

The toner of the present invention contains a styrene acrylic resin as the binder resin.

The styrene acrylic resin includes, for example, a styrene-acrylic acid ester copolymer (e.g., a styrene-methyl acrylate copolymer, a styrene-ethyl acrylate copolymer, a styrene-butyl acrylate copolymer, a styrene-octyl acrylate copolymer, and a styrene-phenyl acrylate copolymer), a styrene-methacrylic acid ester copolymer (e.g., a styrene-methyl methacrylate copolymer, a styrene-ethyl methacrylate copolymer, a styrene-butyl methacrylate copolymer, a styrene-octyl methacrylate copolymer, and a styrene-phenyl methacrylate copolymer), a styrene-methyl α-choroacrylate copolymer, and a styrene-acrylonitrile-acrylic acid ester copolymer.

Such a styrene acrylic resin may be copolymerized, if desired, with a crosslinking monomer and thereby used as a crosslinked resin. As for the production method of the binder resin, a known method is used. The method includes, for example, bulk polymerization, suspension polymerization, solution polymerization, and emulsion polymerization, but the binder resin can be used regardless of the polymerization method.

### (1-2. Charge Control Agent)

The toner of the present invention contains, as the charge control agent, a positive charge control agent and a negative charge control agent. The positive charge control agent contains nigrosine.

As the nigrosine-containing positive charge control agent, a nigrosine-based dye may be used. The nigrosine-based dye specifically includes nigrosine-based dyes BONTRON N-04, BONTRON N-09, BONTRON N-71, BONTRON N-75, etc. produced by Orient Chemical Industries Co., Ltd. Other positive charge control agents include a quaternary ammonium salt such as BONTRON P-51 produced by Orient Chemical Industries Co., Ltd., but this does not contain nigrosine and is not encompassed by the positive charge control agent for use in the present invention.

The negative charge control agent includes, for example, an azo dye containing a metal such as Cr, Co, Al and Fe, a metal salicylate compound, a calixarene compound, and a metal alkyl salicylate compound.

Among negative charge control agents, an azo dye containing a metal such as Cr, Co, Al and Fe and containing as few volatile impurities as possible is preferably used. Such a negative charge control agent specifically includes, for example, BONTRON S-34 and BONTRON E-81 produced by Orient Chemical Industries Co., Ltd.; T77 produced by Hodogaya Chemical Co., Ltd.; LR-147 produced by Japan Carlit Co., Ltd.; and FCA-2521NJ produced by Fujikura Kasei Co., Ltd.

The content of the nigrosine-containing positive charge control agent is usually 0.7 parts by weight or less, preferably 0.3 parts by weight or less, more preferably 0.1 parts by weight or less, per 100 parts by weight of the binder resin. In addition, the content is usually 0.001 parts by weight or more, preferably 0.01 parts by weight or more, more preferably 0.03 parts by weight or more, per 100 parts by weight of the binder resin.

The content of the negative charge control agent is usually 0.5 parts by weight or more, preferably 1.0 parts by weight or more, more preferably 1.2 parts by weight or more, per 100 parts by weight of the binder resin. In addition, the content is usually 30 parts by weight or less, preferably 20 parts by weight or less, more preferably 5 parts by weight or less, per 100 parts by weight of the binder resin.

In the present invention, at least either one of the positive charge control agent and the negative charge control agent is preferably a charge control resin, and it is more preferred that at least the negative charge control agent is a negative charge control resin.

In the toner of the present invention where the binder resin is a styrene acrylic resin, in view of dispersibility of the charge control resin into a toner particle due to good compatibility with the binder resin, among others, a polymer-type negative charge control resin of styrene-acryl copolymer is preferred. Such a negative charge control agent includes, for example, FCA-2521NJ produced by Fujikura Kasei Co., Ltd.

In the toner of the present invention, the content ratio between the positive charge control agent and the negative charge control agent is preferably adjusted such that when the carrier particle for use in the present invention having, on the core material surface, a coating agent containing a fluororesin or a fluoroorganic compound is mixed with the toner for use in the present invention to give a toner concentration of 8%, the toner charge amount becomes from 15 to 30 [μC/g]. Here, the percentage content (weight ratio) of the negative charge control agent in all charge control agents is not less than the percentage content (weight ratio) of the positive charge control agent.

From the viewpoint of obtaining a sufficient image density, the charge amount is preferably 20 [μC/g] or less and on the other hand, is preferably 16 [μC/g] or more and from the viewpoint of obtaining a sufficient image density, more preferably 18 [μC/g] or more.

The toner of the present invention is a positively chargeable toner that is used for a two-component developer containing a carrier particle having a fluororesin or a fluoroorganic compound on the core material surface and contains a binder resin and a charge control agent. The charge control agent contains a positive charge control agent and a negative charge control agent, and the binder resin is a styrene acrylic resin.

In the toner of the present invention, when a carrier particle having a fluororesin or a fluoroorganic compound is mixed with the positively chargeable toner to give a toner concentration of 8%, the toner charge amount Qa is preferably from 15 to 30 [μC/g].

In addition, assuming that the charge amount at the time of mixing of a carrier particle using iron oxide for the core material and having no coating agent on the core material surface with the toner to give a toner concentration of 8% is Qb, the ratio Qa/Qb between Qa and Qb is preferably from 3 to 50.

The ratio (Qa/Qb) between Qa and Qb is an indicator specifying a coating agent amount of the carrier particle having a coating agent containing a fluororesin or a fluoroorganic compound, and a ratio (Qa/Qb) of less than 3 indicates a small covering material amount or an excessive coat amount.

If the coating agent amount is excessive, the ability of imparting an electric charge to the toner is high, leading to a large toner charge amount, and since the toner attaches to the carrier surface by an electrostatic force and covers the carrier surface, the electric charge imparting ability of the carrier to the toner is significantly impaired, as a result, the toner charge amount may become insufficient.

On the other hand, if (Qa/Qb) exceeds 50, although the toner does not attach to the carrier surface, the image density may become insufficient.

Accordingly, the ratio (Qa/Qb) between Qa and Qb is 3 or more, preferably 10 or more, more preferably 15 or more, and still more preferably 18 or more. On the other hand, the ratio (Qa/Qb) between Qa and Qb is 50 or less, preferably 30 or less, and from the viewpoint of obtaining a sufficient image density, more preferably 20 or less. The toner charge amount here is a value as measured by a charge amount distribution measuring apparatus such as E-SPART ANALYZER manufactured by Hosokawamicron Corp.

### (1-3. Coloring Agent)

As to the coloring agent usable for the toner of the present invention, an appropriate coloring agent selected from those known to be usable for a toner may be used. Specific examples of the coloring agent include carbon black, Aniline Blue, Phthalocyanine Blue, Phthalocyanine Green, Hansa Yellow, Rhodamine dyes/pigments, Chromium Yellow, quinacridone, Benzidine Yellow, Rose Bengal, triallylmethane dyes, and monoazo, disazo and condensed azo dyes/pigments, and any one of these known dyes/pigments may be used alone, or a plurality thereof may be used in combination.

In the case of a full-color toner, it is preferable to use Benzidine Yellow or a monoazo or condensed azo dye/pigment for yellow, quinacridone or a monoazo dye/pigment for magenta, and Phthalocyanine Blue for cyan. As the black pigment, carbon black, a coloring agent toned to black color by mixing the above-described yellow pigment/magenta pigment/cyan pigment, or a magnetic material is utilized.

Among these, carbon black as a black pigment is present in the form of an aggregate of very fine primary particles and when dispersed as a pigment dispersion element, coarsening of a particle due to re-aggregation is likely to occur. The degree of re-aggregation of carbon black particles is correlated with the amount of impurities (the residual amount of non-decomposed organic substances) contained in carbon black and when the amount of impurities is large, significant coarsening tends to occur due to re-aggregation after dispersion.

As the quantitative evaluation of the amount of impurities, the ultraviolet ray absorbance of a toluene extract of carbon black as measured by the following method is preferably at 0.05 or less, and more preferably 0.03 or less. In general, carbon black by a channel method tends to have a large amount of impurities, and the carbon black for use in the present invention is therefore preferably carbon black produced by a furnace method.

### (1-4. Wax)

As the wax that can be incorporated into the toner of the present invention, although a known wax may be used at will, the wax specifically includes the followings.

The wax includes, for example, petroleum-based wax and a derivative thereof, such as paraffin wax, microcrystalline wax and petrolatum, montan wax and a derivative thereof, a hydrocarbon wax by Fischer-Tropsch process and a derivative thereof, a polyolefin wax and a derivative thereof, such as polyethylene, natural wax and a derivative thereof (the derivative includes an oxide, a block-copolymerization product with a vinyl-based monomer, and a graft-modification product), such as carnauba wax and candelilla wax, a higher aliphatic alcohol, a fatty acid or acid amide wax such as stearic acid and palmitic acid, an ester wax, a ketone, hydrogenated castor oil and a derivative thereof, plant wax, animal wax, and silicone wax. One of these waxes may be used alone, or two or more thereof may be used in combination.

In the case where the toner of the present invention contains wax, the content thereof is usually 1 part by weight or more, preferably 2 parts by weight or more, more preferably 4 parts by weight or more, per 100 parts by weight of the binder resin.

On the other hand, the content of the wax is usually 15 parts by weight or less, preferably 12 parts by weight or less, more preferably 10 parts by weight or less, per 100 parts by weight of the binder resin. If the wax content in the toner is too small, the offset resistance may be insufficient. If the wax content in the toner is too large, the blocking resistance may insufficient, or the wax may escape from the toner to contaminate the apparatus.

### (1-5. External Additive)

In the toner of the present invention, an external additive may be fixed or attached to the surface of a toner mother particle. As the external additive, an appropriate additive selected from those known to be usable for a toner may be used.

The external additive may have one or more kinds of hydrophobic silica, inorganic oxide fine particles, organic fine particles, etc. The inorganic oxide fine particle includes, for example, an inorganic particle of titanium oxide, aluminum oxide, magnetite, zinc oxide, tin oxide, barium titanate, strontium titanate, etc. The organic fine particle includes, for example, a fine particle of styrene-based resin, acrylic resin, epoxy-based resin, melamine-based resin, etc.

In the toner used for the present invention, the content of the external additive is not particularly limited but is usually 0.1 parts by weight or more, preferably 0.5 parts by weight or more, and more preferably 0.8 parts by weight or more, per 100 parts by weight of the toner mother particle. On the other hand, the content is usually 6 parts by weight or less, preferably 5 parts by weight or less, and more preferably 4 parts by weight or less, per 100 parts by weight of the toner mother particle.

The method for adding the external additive includes, for example, a method using a high-speed stirrer such as Henschel mixer, and a method using an apparatus capable of applying a compressive shearing stress.

The externally-added toner may be produced by a one-stage external addition method of performing external addition by adding all external additives at a time to the toner mother particle but may be produced by a stepwise external addition method of adding external additives individually.

With respect to the temperature at the time of external addition, it is preferable for preventing a temperature rise to provide a cooling device to the container or employ stepwise external addition.

### <2. Carrier Particle>

The carrier particle used at applying the toner of the present invention to a two-component developer has a coating agent containing a fluororesin or a fluoroorganic compound, on the core material surface.

### (2-1. Core Material)

In the present invention, the core material of the carrier is not particularly limited and includes, for example, a magnetic metal such as iron and nickel, and a magnetic oxide such as ferrite and magnetite.

The particle diameter of the core material is preferably from 15 to 80 μm in view of resolution and prevention of carrier scattering. In the case of using ferrite for the core material, the ferrite particle is preferably a particle containing, as the main component, an oxide of one or more elements selected from Li, Mg, Mn, Ni, Cu, Zn and Sr, and Fe₂O₃, and among others, Cu—Mn ferrite, Mn—Zn ferrite and Mn—Mg ferrite are more preferred.

### (2-2. Coating Agent)

The coating agent of the carrier particle contains a fluororesin or a fluoroorganic compound. The fluororesin may be sufficient if it is a fluorine-containing polymer. The fluoroorganic compound includes a fluorine-containing low-molecular organic material such as fluorine-containing coupling agent, fluorine-containing alcohol, fluorine-containing surfactant and fluorine-containing carboxylic acid. Among these, a fluorine-containing polymer is preferred.

In addition, the coating agent may contain a silicone resin such as straight silicon composed of only an organosiloxane bond or silicone resin modified with alkyd, polyester, epoxy, acryl, urethane, etc., or for adjusting the resistance of the coating agent, may contain a resistant electroconductive powder such as carbon black.

In the case of using a silicone resin, etc. in combination with a fluororesin or a fluoroorganic compound, the total coated amount of the coating agent is not particularly limited but is usually 0.1 parts by weight or more, preferably 0.3 parts by weigh or more, more preferably 0.5 parts by weight or more, per 100 parts by weight of the core material.

On the other hand, in the case of using a silicone resin, etc. in combination with a fluororesin or a fluoroorganic compound, the total coated amount of the coating agent is usually 5 parts by weight or less and in view of durability of the coating agent and electric charge imparting ability, preferably 3 parts by weight or less, and more preferably 2 parts by weight or less, per 100 parts by weight of the core material.

The content of the fluororesin or fluoroorganic compound as a coating agent is not particularly limited but is usually 30 parts by weight or more and in view of electric charge imparting ability, preferably 40 parts by weigh or more, more preferably 50 parts by weight or more, per 100 parts by weight of the coating agent.

On the other hand, the content is usually 90 parts by weight or less and in view of balance between durability of the coating agent and chargeability, preferably 80 parts by weigh or less, and more preferably 70 parts by weight or less, per 100 parts by weight of the coating agent.

### (2-3. Particle Size Distribution of Carrier Particle)

The volume average primary particle diameter of the carrier particle is not particularly limited but is usually 20 μm or more, preferably 30 μm or more, and more preferably 40 μm or more. On the other hand, the volume average primary particle diameter of the carrier particle is usually 100 μm or less, and preferably 80 μm or less.

### <3. Developer>

The toner of the present invention is used as a two-component developer together with the above-described carrier particle.

When a developer is obtained, the charge amount of the toner in the developer is not particularly limited as long as the effects of the present invention are not significantly impaired, but the toner charge amount is preferably from 20 to 60 μC/g. If the charge amount falls below the lower limit above, the fog is worsened to increase the toner consumption, or the toner flies from the developer. If the charge amount exceeds the upper limit above, thinning, blurring, etc. of characters occur. The method for measuring the toner charge amount is described in Examples later.

In the case of using the toner of the present invention as a replenishment developer filled into a toner cartridge, assuming that the amount of the developer is 100 parts by weight, the amount of the carrier particle is preferably from 2 to 10 parts by weight.

On the other hand, in the case of using the toner as a developer initially filled into a developing unit, assuming that the amount of the developer is 100 parts by weight, the amount of the carrier particle is preferably from 80 to 98 parts by weight.

### <4. Image Forming Method>

In the image forming method of the present invention, a so-called trickle developing system of continuously replenishing a developer containing a toner and a carrier with discharging an excessive developer is adopted. Furthermore, in the present invention, a so-called touchdown developing system (hybrid developing system) of generating a magnetic brush of the carrier by means of a magnetic roller, supplying a toner to the developing roller surface from the magnetic brush to form a toner thin layer, and selectively attaching the toner on the developing roller surface to an electrostatic latent image holding member according to an electrostatic latent image is adopted.

At the time of selectively attaching the toner on the developing roller surface to an electrostatic latent image holding member according to an electrostatic latent image, the toner on the developing roller surface is preferably caused to fly and attach to an electrostatic latent image holding member.

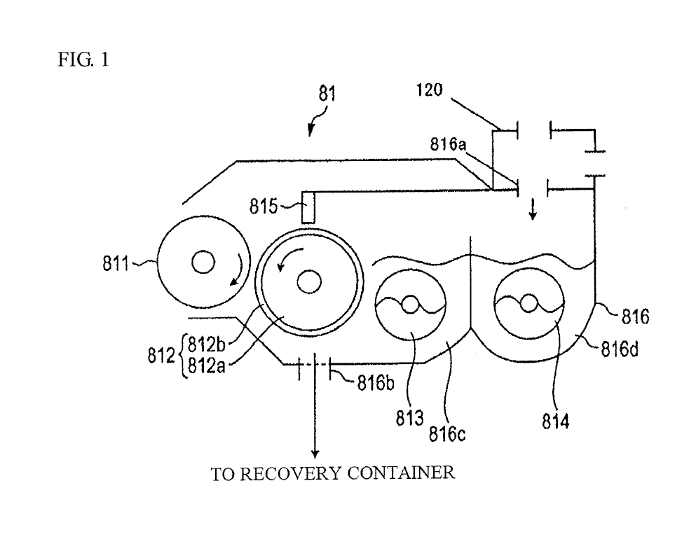

The electrophotographic apparatus where the image forming method adopting these developing systems can be conducted is disclosed, for example, in JP-A-2015-1605. Specifically, as illustrated in FIG. 1, a developing section 81 includes a developing roller 811 (toner holding member), a magnetic roller 812 (conveying roller), stirring members 813 and 814, a developer regulating member 815, a developing container 816, etc.

More specifically, in the developing section 81, a toner image is formed on an electrostatic latent image holding member (photoreceptor drum) by a so-called touchdown developing system (hybrid developing system) in which a two-component developing system and a one-component developing system are combined. In addition, in the developing section 81, a trickle developing system of gradually replacing the developer is adopted.

More specifically, the developing section 81 is configured to periodically replenish the developer from the developer replenishing port 816a and discharge an excessive developer from the developer discharge port 816b (trickle mechanism). A known trickle mechanism of circulation overflow type or liquid-level overflow type can be applied.

In this mechanism, a deteriorated carrier is replaced by a new carrier and in turn, the toner in the developing container 816 is always charged uniformly. Consequently, a stable image quality can be realized without depending on the number of printed sheets or environmental variations.

In the toner used for the image forming method of the present invention, the developer initially filled into the developing unit may be the same as or different from the replenishment developer.

### <5. Method for Measuring Charge Amount>

The toner charge amount can be measured, for example, by the following method. First, a carrier and a toner are mixed to give a toner concentration of 8%. The mixing is performed at a speed of 500 min⁻¹ for 30 minutes in a reciprocating shaker manufactured by TAITEC Corp. After mixing for 30 minutes, the mixture of a carrier and a toner is measured for the charge amount by means of E-SPART ANALYZER manufactured by Hosokawamicron Corp.

Utilizing particle migration in an electric field created by a DC electrode, the particle migration velocity in the electric field is measured by measuring the beat frequency generated from particles traveling in a detection region where two laser beams intersect, and the toner charge amount q is determined from the measured velocity and the particle diameter.

q=(3πηdv)/(EC)

q: toner charge amount [μC/g], η: air viscosity [kg/(ms)], C: Cunningham correction factor, E: field intensity of electric field [V/m], d: aerodynamic particle diameter [μm], v: particle migration velocity to electrode [m/s].

### EXAMPLES

### <Method for Measuring Toner Charge Amount>

The toner charge amount was measured by means of E-SPART ANALYZER manufactured by Hosokawamicron Corp.

Utilizing particle migration in an electric field created by a DC electrode, the particle migration velocity in the electric field was measured by measuring the beat frequency generated from particles traveling in a detection region where two laser beams intersect, and the toner charge amount q was determined from the measured velocity and the particle diameter.

q=(3πηdv)/(EC)

q: toner charge amount [μC/g], η: air viscosity [kg/(ms)], C: Cunningham correction factor, E: field intensity of electric field [V/m], d: aerodynamic particle diameter [μm], v: particle migration velocity to electrode [m/s].

### Example 1

After dispersing and mixing 100 Parts by weight of styrene acrylic resin: CPR190 (produced by Nippon Carbide Industries Co., Ltd.), 0.1 parts by weight of positive charge control agent A: BONTORON N-71 (produced by Orient Chemical Industries Co., Ltd.), 1.2 parts by weight of negative charge control agent B: FCA-2521NJ (produced by Fujikura Kasei Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 1.

As to the carrier combined with Toner 1, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 1 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.). As a result, the toner charge amount Qa was 20.3 [μC/g].

Similarly, a carrier particle, in which the core material is iron and a coating agent is not present on the core material surface, and Toner 1 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.), as a result, the toner charge amount Qb was 0.7 [μC/g].

From Qa and Qb measured above, Qa/Qb was found to be 29.0.

After adding the thus-obtained carrier particle and Toner 1 to give a carrier concentration of 3%, an endurance test of image properties was performed using TASKalfa 5500i of KYOCERA Document Solutions Inc. As a result, no ghost was generated, and when the black solid part was measured by a Macbeth densitometer, the change in the image density between immediately after the start of endurance and after the end of endurance was 0.01.

### Example 2

After dispersing and mixing 100 Parts by weight of styrene acrylic resin: CPR190 (produced by Nippon Carbide Industries Co., Ltd.), 0.3 parts by weight of positive charge control agent A: BONTORON N-71 (produced by Orient Chemical Industries Co., Ltd.), 1.2 parts by weight of negative charge control agent B: FCA-2521NJ (produced by Fujikura Kasei Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 2.

As to the carrier combined with Toner 2, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 2 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.). As a result, the toner charge amount Qa was 22.9 [μC/g].

After adding the thus-obtained carrier particle and Toner 2 to give a carrier concentration of 3%, an endurance test of image properties was performed using TASKalfa 5500i of KYOCERA Document Solutions Inc. As a result, no ghost was generated, and the change in the image density between immediately after the start of endurance and after the end of endurance was 0.02.

### Example 3

After dispersing and mixing 100 Parts by weight of styrene acrylic resin: CPR190 (produced by Nippon Carbide Industries Co., Ltd.), 0.6 parts by weight of positive charge control agent A: BONTORON N-71 (produced by Orient Chemical Industries Co., Ltd.), 0.6 parts by weight of negative charge control agent B: FCA-2521NJ (produced by Fujikura Kasei Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 3.

As to the carrier combined with Toner 3, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 3 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.). As a result, the toner charge amount Qa was 25.7 [μC/g].

Similarly, a carrier particle, in which the core material is iron and a coating agent is not present on the core material surface, and Toner 3 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.), as a result, the toner charge amount Qb was 4.2 [μC/g].

From Qa and Qb measured above, Qa/Qb was found to be 6.1. In addition, after adding the thus-obtained carrier particle and Toner 3 to give a carrier concentration of 3%, an endurance test of image properties was performed using TASKalfa 5500i of KYOCERA Document Solutions Inc. As a result, no ghost was generated, and the change in the image density between immediately after the start of endurance and after the end of endurance was 0.02.

### Comparative Example 1

After dispersing and mixing 100 Parts by weight of styrene acrylic resin: CPR190 (produced by Nippon Carbide Industries Co., Ltd.), 0.6 parts by weight of positive charge control agent A: BONTORON N-71 (produced by Orient Chemical Industries Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 4.

As to the carrier combined with Toner 4, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 4 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.). As a result, the toner charge amount Qa was 4.4 [μC/g].

Similarly, a carrier particle, in which the core material is iron and a coating agent is not present on the core material surface, and Toner 4 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.), as a result, the toner charge amount Qb was 7.3 [μμC/g].

From Qa and Qb measured above, Qa/Qb was found to be 0.6. In addition, after adding the thus-obtained carrier particle and Toner 4 to give a carrier concentration of 3%, an endurance test of image properties was performed using TASKalfa 5500i of KYOCERA Document Solutions Inc. As a result, no ghost was generated, and the change in the image density between immediately after the start of endurance and after the end of endurance was 0.20.

### Comparative Example 2

After dispersing and mixing 100 Parts by weight of styrene acrylic resin: CPR190 (produced by Nippon Carbide Industries Co., Ltd.), 0.1 parts by weight of positive charge control agent B: P-51 (produced by Orient Chemical Industries Co., Ltd.), 1.2 parts by weight of negative charge control agent B: FCA-2521NJ (produced by Fujikura Kasei Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 5.

As to the carrier combined with Toner 5, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene and thereafter subjected to heat treatment. After adding the thus-obtained carrier particle and Toner 5 to give a carrier concentration of 3%, an endurance test of image properties was performed using TASKalfa 5500i of KYOCERA Document Solutions Inc. As a result, no ghost was generated, and the change in the image density between immediately after the start of endurance and after the end of endurance was 0.38.

### Comparative Example 3

After dispersing and mixing 100 Parts by weight of polyester resin: M-302 (produced by Sanyo Chemical Industries, Ltd.), 0.5 parts by weight of positive charge control agent A: BONTORON N-71 (produced by Orient Chemical Industries Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 6.

As to the carrier combined with Toner 6, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K K) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 6 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.). As a result, the toner charge amount Qa was 8.3 [μC/g].

After adding the thus-obtained carrier particle and Toner 6 to give a carrier concentration of 3%, an endurance test of image properties was performed using TASKalfa 5500i of KYOCERA Document Solutions Inc. As a result, no ghost was generated, and the change in the image density between immediately after the start of endurance and after the end of endurance was 0.34.

### Comparative Example 4

After dispersing and mixing 100 Parts by weight of styrene acrylic resin: CPR190 (produced by Nippon Carbide Industries Co., Ltd.), 0.6 parts by weight of positive charge control agent A: BONTORON N-71 (produced by Orient Chemical Industries Co., Ltd.), 0.3 parts by weight of negative charge control agent B: FCA-2521NJ (produced by Fujikura Kasei Co., Ltd.), 2 parts by weight of wax: VISCOL 660P (produced by Sanyo Chemical Industries, Ltd.), and 6 parts by weight of carbon black: LEAGAL 330R (produced by Cabot Specialty Chemicals, Inc.), melt-kneading using a twin-screw extruder was carried out.

After cooling, the kneaded material was coarsely pulverized with a hammer mill and then finely pulverized with a supersonic jet mill pulverizer. The resulting powder was classified by an air classifier to obtain a toner having a particle diameter of 10 μm. Furthermore, relative to 100 parts by weight of the toner, 0.2 parts by weight of hydrophobic silica: H13TD (produced by Wacker Chemie AG), 1.5 parts by weight of hydrophobic silica: NA130K (produced by Nippon Aerosil Co., Ltd.), and 1.0 parts by weight of electrically conductive titania: ET500W (produced by Ishihara Sangyo Kaisha, Ltd.) were externally added by means of a super-mixer to obtain Toner 7.

As to the carrier combined with Toner 7, ferrite was used as the core material, and the core material was spray-coated, relative to 100 parts by weight of the core material, with a coating agent solution prepared by dispersing 0.6 parts by weight of Teflon (registered trademark) S954-100 (produced by DuPont K.K.) in methyl ethyl ketone and a coating agent solution prepared by dispersing 0.6 parts by weight of silicone resin SR2410 (produced by Dow Corning Toray Co., Ltd.) in toluene.

The carrier particle, which was thereafter subjected to heat treatment, and Toner 7 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.), as a result, the toner charge amount Qa was 12.0 [μC/g].

Similarly, a carrier particle, in which the core material is iron and a coating agent is not present on the core material surface, and Toner 7 were added to give a toner concentration of 8% and mixed at a speed of 500 min⁻¹ for 30 minutes in a reciprocating shaker manufactured by TEITEC Corp., and the mixture of the carrier particle and the toner was measured by means of a charge amount distribution device, E-SPART ANALYZER (manufactured by Hosokawamicron Corp.), as a result, the toner charge amount Qb was 6.6 [μC/g].

From Qa and Qb measured above, Qa/Qb was found to be 1.8. After adding the thus-obtained carrier particle and Toner 7 to give a carrier concentration of 3%, an endurance test of image properties was performed using TASKalfa 5500i of KYOCERA Document Solutions Inc. As a result, no ghost was generated, and when the change in the image density between immediately after the start of endurance and after the end of endurance was 0.02.

### <Evaluation>

The toners obtained in Examples and Comparative Examples were evaluated for the following items based on the following criteria. The results are shown in Table 1.

Image Density: Measured value of black solid part by Macbeth densitometer

AA: 1.30 or more

A: from 1.20 to less than 1.30

B: from 1.00 to less than 1.20

C: less than 1.00

Change in Image Density: Difference between maximum value and minimum value of image density in printing durability evaluation

AA: less than 0.10

A: from 0.10 to less than 0.15

B: from 0.15 to less than 0.20

C: 0.20 or more

Fog: Difference of measured value in white part between before and after printing by means of Hunter colorimeter

AA: less than 0.5

A: from 0.5 to less than 1.0

B: from 1.0 to less than 2.0

C: 2.0 or more

Ghost (amount of toner attached): Evaluation by actual printing in TASKalfa 5500i of KYOCERA Document Solutions Inc.

C: Generation of ghost is observed.

A: Generation of ghost is not observed.

TABLE 1

| | | | | | | Comparative | Comparative | Comparative | Comparative |
|---|---|---|---|---|---|---|---|---|---|
| | | | Example 1 | Example 2 | Example 3 | Example 1 | Example 2 | Example 3 | Example 4 |
| Binder resin | | | styrene-acryl | styrene-acryl | styrene-acryl | styrene-acryl | styrene-acryl | polyester | styrene-acryl |
| Coating agent | | | fluorine | fluorine | fluorine | fluorine | fluorine | fluorine | fluorine |
| CCA | Positive | N71 | 0.1 | 0.3 | 0.6 | 0.6 | 0 | 0.5 | 0.6 |
| (charge | charge | (parts by weight) | | | | | | | |
| control | control | P51 | 0 | 0 | 0 | 0 | 0.1 | 0 | 0 |
| agent) | agent | (parts by weight) | | | | | | | |
| | Negative | FCA2521NJ | 1.2 | 1.2 | 0.6 | 0 | 1.2 | 0 | 0.3 |
| | charge | (parts by weight) | | | | | | | |
| | control | | | | | | | | |
| | agent | | | | | | | | |

| | | | | | | | |
|---|---|---|---|---|---|---|---|
| Negative charge control | 92% | 80% | 50% | 0% | 92% | 0% | 44% |
| agent content ratio | | | | | | | |
| (mass ratio) | | | | | | | |
| Qa | 20.3 | 23.9 | 25.7 | 4.4 | — | 8.3 | 12.0 |
| Qb | 0.7 | — | 4.2 | 7.3 | — | — | 6.6 |
| Qa/Qb | 29.0 | — | 6.1 | 0.6 | — | — | 1.8 |
| Image density | AA | A | A | C | C | C | C |
| Change in image density | AA (0.01) | AA (0.02) | AA (0.02) | C (0.20) | C (0.38) | C (0.34) | AA (0.02) |
| Fog | AA | A | A | C | C | C | C |
| Ghost (amount of toner attached) | A | A | A | C | C | C | C |

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2015-067190) filed on Mar. 27, 2015, the entirety of which is incorporated herein by way of reference.

### INDUSTRIAL APPLICABILITY

According to the present invention, the toner charge amount is proper, and attachment of the toner to the carrier particle surface is thereby suppressed. Therefore, an electric charge can be supplied to the toner without impairing the charge imparting ability of the carrier particle. As a result, an image failure of ghost does not occur, and image formation with excellent image density stability can be performed, which is useful in industry.

### DESCRIPTION OF REFERENCE NUMERALS AND SIGNS

81 Developing section
811 Developing roller (toner holding member)
812 Magnetic roller (conveying roller)
82 Toner supply section
83 Toner supply channel
816 Developing container

1. An electrostatic charge image developing toner comprising a binder resin and a charge control agent, wherein:
the binder resin is a styrene acrylic resin,
the charge control agent contains a positive charge control agent and a negative charge control agent,
the positive charge control agent contains nigrosine,
the percentage content of the negative charge control agent in all charge control agents is not less than the percentage content of the positive charge control agent, and
the toner has positive chargeability.

2. A two-component developer comprising the electrostatic charge image developing toner according to claim 1 and a carrier, wherein the carrier has a fluororesin or a fluoroorganic compound on the core material surface.

3. An image forming method comprising:
continuously replenishing a developer comprising a toner and a carrier with discharging an excessive developer,
generating a magnetic brush of the carrier by means of a magnetic roller,
supplying a toner to the developing roller surface from the magnetic brush to form a toner thin layer, and
selectively attaching the toner on the developing roller surface to an electrostatic latent image holding member according to an electrostatic latent image, wherein:
the carrier has a fluororesin or a fluoroorganic compound on the core material surface,
the toner contains a charge control agent and a binder resin composed of a styrene acrylic resin and has positive chargeability,
the charge control agent contains a positive charge control agent and a negative charge control agent, and
the positive charge control agent is nigrosine.

4. The image forming method according to claim 3, wherein the toner on the developing roller surface is caused to selectively fly to an electrostatic latent image holding member in accordance with an electrostatic image.

5. The image forming method according to claim 3, wherein the negative charge control agent is a charge control resin.

6. An electrostatic charge image developing toner comprising a binder resin and a charge control agent, wherein
the binder resin is a styrene acrylic resin,
the charge control agent contains a positive charge control agent and a negative charge control agent,
the positive charge control agent contains nigrosine, and
when a carrier particle having a fluororesin or a fluoroorganic compound is mixed with the toner to give a toner concentration of 8%, the toner charge amount Qa is from 15 to 30 [μC/g].
